(19) United States
(12) Patent Application Publication
(10) Pub. No.: US 2014/0189857 A1
(43) Pub. Date: Jul. 3, 2014

(54) METHOD, SYSTEM, AND APPARATUS FOR SECURELY OPERATING COMPUTER

(71) Applicant: EMC Corporation, Hopkinton, MA (US)

(72) Inventors: Feng Guo, Shanghai (CN); Qiyan Chen, Shanghai (CN); Tianqing Wang, Shanghai (CN); Lintao Wan, Shanghai (CN); Ziye Yang, Shanghai (CN)

(73) Assignee: EMC Corporation, Hopkinton, MA (US)

(21) Appl. No.: 14/143,295

(22) Filed: Dec. 30, 2013

(30) Foreign Application Priority Data
Dec. 31, 2012 (CN) CN201210596219.3

(51) Int. Cl. G06F 21/00; G06F 21/35

(52) U.S. Cl. CPC G06F 21/00; G06F 21/35
USPC 726/20; 726/16

(57) ABSTRACT

The present invention provides a method, system and apparatus for securely operating a computer. The method comprises: obtaining presence status of an authenticated user, the presence status indicating whether the authenticated user is present in the vicinity of the computer; and triggering security operation in response to that the presence status indicates the authenticated user is absent in the vicinity of the computer. By means of the method, current status of an authenticated user who has logged in can be easily learned, and in turn, corresponding security operation is performed; in addition, when a user is performing sensitive operation, it can be confirmed in real time whether the user is an authenticated user who previously logged in, so that security of operating the computer is improved.

### BACKGROUND

Embodiments of the present invention relate to the field of secure access, and more specifically, to a method, system and apparatus for securely operating a computer.

With the rapid development of computer and information technology, information gets increasingly valuable to any corporations. Although corporations are continuously hardening their security awareness, they are still facing many security problems.

Firstly, an unlocked computer may become a huge threat to corporation security, especially, some confidential information is shown on the computer screen. However, it is hard to ask employees to lock their computers before walking away. On the one hand, some employees do not have enough security awareness. On the other hand, employees may forget to lock their computers when going away for answering an urgent phone call. Secondly, there lacks a way to detect if high-risk operation is performed by a computer owner, a hacker or a malicious user. For example, if a hacker got the password of a computer, when the computer owner leaves, the hacker can do whatever he wants on the computer. The security protection software cannot prevent the occurrence of such information loss, since it does not know the exact identity of the operator.

In short, currently there lacks a technology to be aware of presence status of a user. Once it is learned whether the information owner is present or not, many intelligent security protections can be applied to secure important information.

### SUMMARY

To solve the above problems in the prior art, this specification proposes a technical solution as below.

According to a first aspect of the present invention, there is provided a method for securely operating a computer, comprising: obtaining presence status of an authenticated user, the presence status indicating whether the authenticated user is present in the vicinity of the computer; and triggering security operation in response to that the presence status indicates the authenticated user is absent in the vicinity of the computer.

In an optional implementation of the present invention, the presence status is obtained based on communication status between a RFID reader for the computer and a RFID tag for the user.

In an optional implementation of the present invention, the obtaining presence status of an authenticated user further comprises: after the authenticated user logs into the computer, subscribing to an event regarding presence status change of the authenticated user, thereby when the authenticated user leaves the computer, obtaining a message notified automatically and indicating the authenticated user is absent in the vicinity of the computer.

In an optional implementation of the present invention, the method is triggered by the authenticated user's sensitive operation. In a further optional implementation of the present invention, the sensitive operation is performed on the computer. In another further optional implementation of the present invention, the sensitive operation is performed by logging into another computer via the computer. In an optional implementation of the present invention, the sensitive operation comprises one or more of operation related to financial information, operation related to encrypted information, and operation related to system kernel information.

In an optional implementation of the present invention, the security operation comprises one or more of locking screen, rejecting operation, blocking access, and notifying the authenticated user.

In an optional implementation of the present invention, the RFID tag for the authenticated user is attached to the body and/or accessory of the authenticated user.

According to a second aspect of the present invention, there is provided a system for providing secure operation to a computer, comprising: an identity tag disposed on an authenticated user, comprising a RFID tag; a tag recognition module disposed on the computer, comprising a RFID reader, the tag recognition module generating and/or updating presence status of the authenticated user based on communication status between the RFID reader and the identity tag within the identity tag, the presence status indicating whether the authenticated user is present in the vicinity of computer; and a security management module communicatively coupled to the tag recognition module, configured to trigger security operations in response to that the generated presence status of the authenticated user indicates the authenticated user is absent in the vicinity of the computer.

In an optional implementation of the present invention, the system further comprises an information maintenance module comprising a repository and configured to maintain the presence status generated by the tag recognition module.

In an optional implementation of the present invention, the tag recognition module periodically updates the generated or updated presence status of the authenticated user to the information maintenance module via a message, and the message comprises one or more of the following relevant information: an identity tag identification code, an IP address of the computer, a specific identity tag being present in the vicinity of the computer, and a specific identity tag leaving the computer.

In an optional implementation of the present invention, after the authenticated user logs into the computer, the security management module subscribes to the information maintenance module for an event regarding presence status change of the authenticated user, so when the authenticated user leaves the computer, the security management module obtains a message automatically notified by the information maintenance module and indicating the authenticated user is absent in the vicinity of the computer.

In an optional implementation of the present invention, the security management module being configured to trigger security operations in response to that the generated presence status of the authenticated user indicates the authenticated user is absent in the vicinity of the computer further comprises: when the security management module detects the authenticated user's sensitive operation, querying the information maintenance module about presence status of the authenticated user; and in response to that the presence status of the authenticated user indicates the authenticated user is absent in the vicinity of the computer, triggering security operation. In a further optional implementation of the present invention, the sensitive operation is performed on the computer, and the security management module is disposed on the computer. In another further optional implementation of the present invention, the sensitive operation is performed by logging into another computer via the computer, and the security management module is disposed on said another computer.

In an optional implementation of the present invention, the sensitive operation comprises one or more of operation related to financial information, operation related to encrypted information, and operation related to system kernel information.

In an optional implementation of the present invention, the security operation comprises one or more of locking screen, rejecting operation, blocking access, and notifying the authenticated user.

In an optional implementation of the present invention, the identity tag disposed on the authenticated user is attached to the body and/or accessory of the authenticated user.

According to a third aspect of the present invention, there is provided an apparatus for securely operating a computer, comprising: a status obtaining module configured to obtain presence status of an authenticated user, the presence status indicating whether the authenticated user is present in the vicinity of the computer; and a triggering module configured to trigger security operation in response to that the presence status indicates the authenticated user is absent in the vicinity of the computer.

In an optional implementation of the present invention, the status obtaining module further comprises: a RFID communication module configured to obtain the presence status based on communication status between a RFID reader for the computer and a RFID tag for the user.

In an optional implementation of the present invention, the status obtaining module is further configured to: after the authenticated user logs into the computer, subscribe to an event regarding presence status change of the authenticated user, thereby when the authenticated user leaves the computer, obtaining a message notified automatically and indicating the authenticated user is absent in the vicinity of the computer.

In an optional implementation of the present invention, the apparatus is triggered by the authenticated user's sensitive operation. In a further optional implementation of the present invention, the sensitive operation is performed on the computer. In another further optional implementation of the present invention, the sensitive operation is performed by logging into another computer via the computer.

In an optional implementation of the present invention, the sensitive operation comprises one or more of operation related to financial information, operation related to encrypted information, and operation related to system kernel information.

In an optional implementation of the present invention, the security operation comprises one or more of locking screen, rejecting operation, blocking access, and notifying the authenticated user.

In an optional implementation of the present invention, the RFID tag for the authenticated user is attached to the body and/or accessory of the authenticated user.

By means of the foregoing implementations, current status of an authenticated user who has logged in can be easily learned, and in turn, corresponding security operation is performed; in addition, when a user is performing sensitive operation, it can be confirmed in real time whether the user is an authenticated user who previously logged in, so that security of operating the computer is improved.

### BRIEF DESCRIPTION OF THE SEVERAL VIEWS OF THE DRAWINGS

Through the more detailed description of exemplary embodiments of the present disclosure in the accompanying drawings, the above and other objects, features and advantages of the present disclosure will become more apparent, wherein the same reference generally refers to the same components in the embodiments of the present disclosure.

FIG. 1 shows an exemplary computer system 100 which is applicable to implement the embodiments of the present invention;

FIG. 2 shows a flowchart of a method 200 for securely operating a computer according to one exemplary embodiment of the present invention;

FIGS. 3A and 3B further show an exemplary implementation of a specific step or triggering mechanism of method 200 shown in FIG. 2;

FIGS. 4A and 4B show an exemplary implementation of a system 400 and system 400′ for providing secure operation of a computer according to one exemplary embodiment of the present invention, respectively; and

FIG. 5 shows a block diagram of an apparatus 500 for securely operating a computer according to one embodiment of the present invention.

### DETAILED DESCRIPTION

As various problems that will be encountered in securely operating a computer in the prior art have been described above, some preferable embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

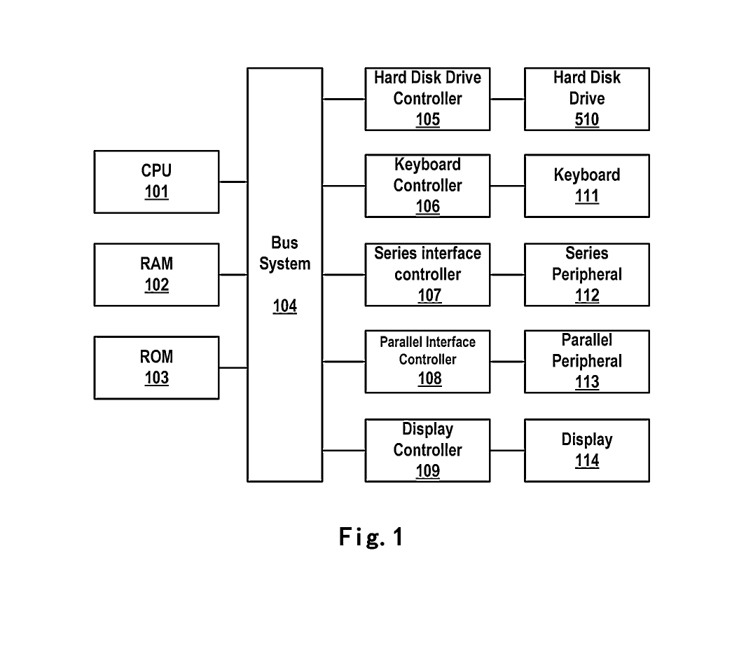

FIG. 1 shows an exemplary computer system 100 which is applicable to implement the embodiments of the present invention. As shown in FIG. 1, the computer system 100 may include: CPU (Central Process Unit) 101, RAM (Random Access Memory) 102, ROM (Read Only Memory) 103, System Bus 104, Hard Drive Controller 105, Keyboard Controller 106, Serial Interface Controller 107, Parallel Interface Controller 108, Display Controller 109, Hard Drive 110, Keyboard 111, Serial Peripheral Equipment 112, Parallel Peripheral Equipment 113 and Display 114. Among above devices, CPU 101, RAM 102, ROM 103, Hard Drive Controller 105, Keyboard Controller 106, Serial Interface Controller 107, Parallel Interface Controller 108 and Display Controller 109 are coupled to the System Bus 104. Hard Drive 110 is coupled to Hard Drive Controller 105. Keyboard 111 is coupled to Keyboard Controller 106. Serial Peripheral Equipment 112 is coupled to Serial Interface Controller 107. Parallel Peripheral Equipment 113 is coupled to Parallel Interface Controller 108. And, Display 114 is coupled to Display Controller 109. It should be understood that the structure as shown in FIG. 1 is only for the exemplary purpose rather than any limitation to the present invention. In some cases, some devices may be added to or removed from the computer system 100 based on specific situations.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operation for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

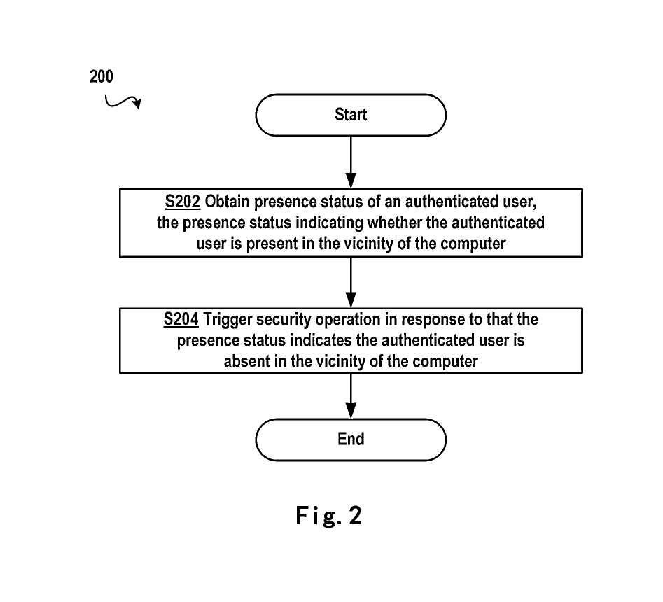

With reference now to FIG. 2, this figure shows a flowchart of a method 200 for securely operating a computer according to one exemplary embodiment of the present invention.

After method 200 starts, the flow first proceeds to step S202 for obtaining presence status of an authenticated user, the presence status indicating whether the authenticated user is present in the vicinity of the computer. According to the concept of the present invention, a very important step that enables to securely operate a computer is to confirm the user operating the computer currently is the authenticated user who has passed authentication at login time. This may be implemented by, for example, judging whether the authenticated user is present in the vicinity of the computer.

Next method 200 proceeds to step S204 for triggering security operation in response to that the presence status indicates the authenticated user is absent in the vicinity of the computer. At this point, it may be considered that the person currently operating the computer is not the authenticated user who logged in previously, so corresponding security operation is triggered. Here the term “security operation” comprises various operation that are performed in order to protect information on the computer, such as, without limitation, locking screen, rejecting operation, blocking access, notifying the authenticated user (in various manners, e.g., via an e-mail), etc.

Lastly method 200 ends.

According to the embodiments of the present invention, in method 200 there may exist various means for obtaining presence status of an authenticated user, such as periodical fingerprint recognition, password inputting, infrared identification, etc. Preferably, the implementation may be based on RFID technology.

Radio-frequency identification (RFID) is such a technology that uses radio waves to transfer data from an electronic tag. A RFID system mainly involves two kinds of hardware known as readers and (electronic) tags (also called transponders). The term “reader” is generally composed of an antenna, a coupling element and a chip, for reading (writing sometimes) tag information. The term “electronic tag” may also be called a RFID tag or label, attached to an object and having a unique electronic code for identifying and tracking the object through a reader. Tags may comprise active tags and passive tags. An active tag having a battery is provided with a wider scope of reading capabilities and stronger communication reliability; the size is relatively large, and the price is also higher. A passive tag does not contain a battery; the power is supplied by the reader. When radio waves from the reader are encountered by a passive RFID tag, the coiled antenna within the tag forms a magnetic field. The tag draws power from it, energizing the circuits in the tag. The tag then sends the information encoded in the tag's memory so that the reader can identify the tag. The price of passive RFID tags is cheap as $0.05 each and the transform distance can be several meters. In the implementation of the present invention, both of the two kinds of RFID tags may be adopted. If cost considered, however, passive tags are preferred.

According to the embodiments of the present invention, based on the RFID technology, there is proposed a preferred solution leveraging the RFID technology: obtaining presence status of an authenticated user based on status of communication between a RFID reader for the computer and a RFID tag for the user. That is, when the RFID reader can read the RFID tag, it is considered that the authenticated user corresponding to the RFID tag is present in the vicinity of the computer, so corresponding operation is indeed performed by the authenticated user. On the contrary, when the RFID reader cannot read the RFID tag, it is considered that the authenticated user corresponding to the RFID tag is absent in the vicinity of the computer, so corresponding operation is not performed by the authenticated user but by other user such as a malicious user or a hacker. Note according to the embodiments of the present invention, the RFID tag may be disposed on the body of a (authenticated) user or on an accessory (such as clothing, mobile phone, wallet, bus pass, etc.).

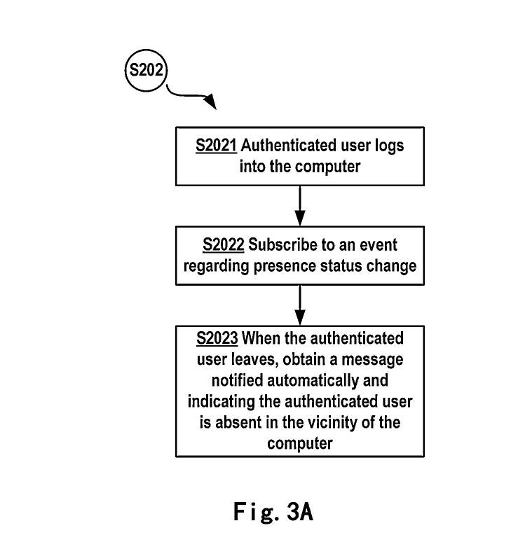

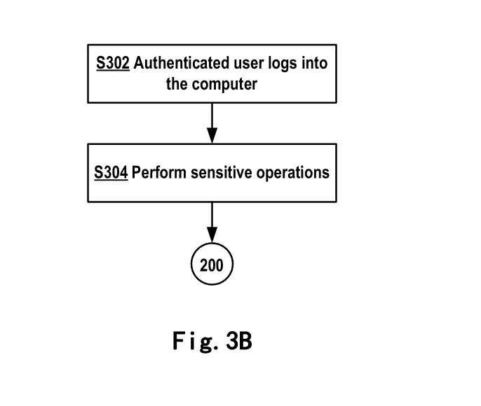

FIG. 3A further shows exemplary implementation of step S202 of method 200 shown in FIG. 2 according to one embodiment of the present invention. Specifically, as shown in FIG. 3A, step S202 may, for example, after an authenticated user logs into the computer (step S2021), subscribe to an event on change of presence status of the authenticated user (step S2022), thereby obtaining a message notified automatically and indicating the authenticated user is absent in the vicinity of the computer (step S2023) when the authenticated user walks away from the computer. In this manner, a presence status message of the authenticated user is obtained.

FIG. 3B further shows a triggering mechanism of method 200 shown in FIG. 2 according to another embodiment of the present invention. As shown in FIG. 3B, after an authenticated user logs into the computer (step S302), once it is detected the authenticated user is performing sensitive operation (step S304), method 200 is triggered. The sensitive operation called here comprises various kinds of high-risk operation that might cause (potential) significant loss, including, without limitation, operation related to financial information, operation related to encrypted information, and operation related to system kernel information.

Those skilled in the art would appreciate the sensitive operation may be directly performed on the computer or remotely performed by logging into another computer via the computer. The present invention is not limited in this regard.

Various implementations of securely operating a computer according to the embodiments have been described in detail with reference to FIGS. 2, 3A and 3B. With the implementations, the authenticated user may actively take security measures while walking away from the computer, and also, the computer system protection may be strengthened by confirming the real presence status of the authenticated user while the authenticated user is performing sensitive operation. In addition, the introduction of the RFID technology greatly reduces the cost of the present invention and improves the application flexibility.

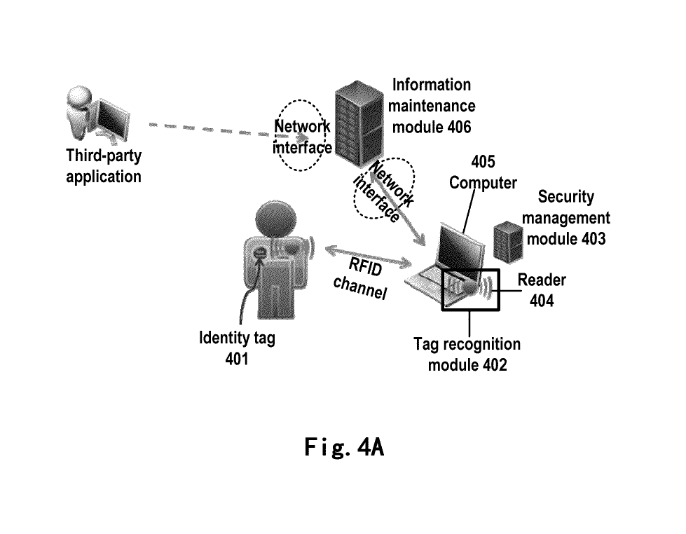

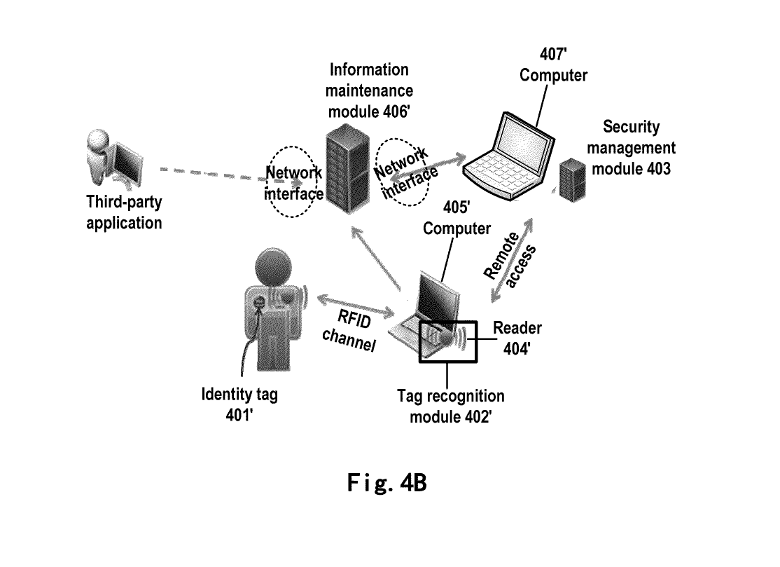

FIG. 4A shows an exemplary implementation of a system 400 for providing secure operation of a computer according to one exemplary embodiment of the present invention.

As shown in FIG. 4A, system 400 comprises: an identity tag 401 disposed at an authenticated user, a tag recognition module 402 disposed on a computer 405, and a security management module 403. In the implementation of the present invention, identity tag 401 may be a token embedding a RFID tag which carries a unique code. When radio waves from a RFID reader are encountered by identity tag 401, the tag sends the encoded unique code so that the RFID reader can identify the tag. An example of suitable identity tag 401 may be a RSA SecurID token with RFID. In the implementation of the present invention, identity tag 401 disposed at the authenticated user may be attached to the body and/or accessories of the authenticated user.

Tag recognition module 402 comprises a RFID reader 404. RFID reader 404 continuously discovers surrounding identity tags 401. Tag recognition module 402 generates and/or updates (in real time) presence status of the authenticated user based on communication status between the RFID reader and identity tag 401, the presence status indicating whether the authenticated user is present in the vicinity of computer 405.

In addition, security management module 403, which is communicatively coupled to tag recognition module 402, is configured to trigger security operation in response to that the generated presence status of the authenticated user indicates the authenticated user is absent in the vicinity of computer 405. Likewise, the security operation comprises one or more of: locking screen, rejecting operation, blocking access, notifying the authenticated user, etc.

According to one embodiment of the present invention, system 400 further comprises an information maintenance module 406 that comprises a repository and is configured to maintain the (real-time) presence status generated by tag recognition module 402. Moreover, in the implementation of the present invention, information maintenance module 406 further provides to third-party applications an interface to query about the people presence status and/or an interface to support (asynchronous) event subscription of the change of people presence status. In the implementation, the repository usually maintains the following two kinds of information:

1) The presence status of each identity tag: an identity tag is either present in the vicinity a computer or absent in the vicinity of all computers.

2) The mapping of people and identity tags: the mapping information associates people with identity tags.

According to one embodiment of the present invention, tag recognition module 402 may periodically update the generated or updated presence status of the authenticated user to information maintenance module 406 via messages. The messages may comprise one or more relevant information: an identity tag identification code, an IP address of the computer, a specific tag being present in the vicinity of the computer, and a specific tag leaving the computer. For example, the messages may be “The identity tag (unique identification code ***) is present in the vicinity of computer (IP address ***)” or “The identity tag (unique identification code ***) leaved computer (IP address ***).” These message forms merely serve as examples and do not limit the spirit and principles of the present invention.

Those skilled in the art would appreciate that security management module 403 and information maintenance module 406 may be implemented in the form of full software, full hardware or combination of software and hardware.

Based on the foregoing description of the construction of system 400, further depiction is presented to a working mode of system 400 according to the embodiment of the present invention.

One preferred working mode is as below: after the authenticated user logs into computer 405 containing confidential information, security management module 403 subscribes to information maintenance module 405 for an event regarding presence status change of the authenticated user. In this manner, after the authenticated user leaves computer 405, security management module 403 will obtain a notification notified by information maintenance module 406 automatically and indicating the authenticated user leaves the computer, thereby triggering security operation such as locking screen and the like.

Another preferred working mode may be as such: upon detecting the authenticated user's sensitive operation such as operation on confidential information or high-risk operation (for example, the user is uploading financial documents to an external website), security management module 403 queries information maintenance module 406 about presence status of the authenticated user who is currently logging in; and in response to that the presence status of the authenticated user indicates the authenticated user is absent in the vicinity of computer 405, security management module 403 triggers security operation. When the authenticated user is present in the vicinity of computer 405, the user's ongoing sensitive operation is permitted. Similarly, the sensitive operation may comprise one or more of operation related to financial information, operation related to encrypted information, and operation related to system kernel information.

Note in one implementation of the present invention, the sensitive operation may be performed on computer 405, at which point security management module 403 may be disposed on computer 405 accordingly, just as shown in FIG. 4A.

In another implementation of the present invention, with reference to FIG. 4B, the sensitive operation may be performed by (remotely) logging into another computer 407′ via computer 405′, in which case tag recognition module 402′ is disposed on computer 405′ physically operated by the user while security management module 403′ is disposed on another computer 407′. When the authenticated user is really present in the vicinity of computer 405′, the sensitive operation performed on computer 407′ is permitted, or else is forbidden.

Similarly, those skilled in the art would appreciate security management module 403′ and information maintenance module 406′ may also be implemented in the form of full software, full hardware or combination of software and hardware.

The latter implementation shown with reference to FIG. 4B potentially provides a way to collaborate with VPN solution to provide an advanced secure authentication, so that the VPN server can be updated to not only verify the user credential but also check the user presence status for granting a remote connection.

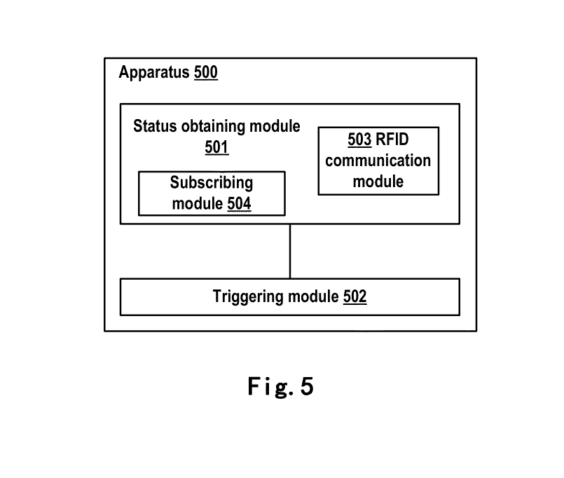

Next with reference to FIG. 5, further description is presented to a block diagram of an apparatus 500 for securely operating a computer according to one embodiment of the present invention.

As shown in FIG. 5, apparatus 500 comprises: a status obtaining module 501 configured to obtain presence status of an authenticated user, the presence status indicating whether the authenticated user is present in the vicinity of the computer; and a triggering module 502 configured to trigger security operation in response to that the presence status indicates the authenticated user is absent in the vicinity of the computer.

In the implementation of the present invention, status obtaining module 501 further comprises: a RFID communication module 503 configured to obtain the presence status based on communication status between a RFID reader for the computer and a RFID tag for the user.

In the implementation of the present invention, status obtaining module 501 further comprises: a subscribing module 504 configured to after the authenticated user logs into the computer, subscribe to an event regarding presence status change of the authenticated user, thereby when the authenticated user leaves the computer, obtaining a message notified automatically and indicating the authenticated user is absent in the vicinity of the computer.

In the implementation of the present invention, apparatus 500 is triggered by the authenticated user's sensitive operation. In further implementation of the present invention, the sensitive operation is performed on the computer. In another further implementation of the present invention, the sensitive operation is performed by logging into another computer via the computer.

In the implementation of the present invention, the sensitive operation comprises one or more of operation related to financial information, operation related to encrypted information, and operation related to system kernel information.

In the implementation of the present invention, the security operation comprises one or more of locking screen, rejecting operation, blocking access, and notifying the authenticated user.

In the implementation of the present invention, the RFID tag for the authenticated user is attached to the body and/or an accessory of the authenticated user.

Various embodiments of the present invention have been described above. As seen from the foregoing description, the method, system and apparatus for securely operating a computer according to the present invention can learn whether a user who is currently performing operation is the information owner or other malicious user who gets the password illegally, and further take a corresponding security measure when deciding a malicious user. On the other hand, when the information owner leaves the computer, security measures can be taken actively so as to strengthen the protection of computer system information. Furthermore, as described above, the introduction of the RFID technology greatly reduces the implementation cost of the present invention and improves the flexibility of applications.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for securely operating a computer, comprising:
obtaining presence status of an authenticated user, the presence status indicating whether the authenticated user is present in the vicinity of the computer; and
triggering security operation in response to that the presence status indicates the authenticated user is absent in the vicinity of the computer.

2. The method according to claim 1, wherein the presence status is obtained based on communication status between a RFID reader for the computer and a RFID tag for the user.

3. The method according to claim 1, wherein the obtaining presence status of an authenticated user further comprises:
after the authenticated user logs into the computer, subscribing to an event regarding presence status change of the authenticated user, thereby when the authenticated user leaves the computer, obtaining a message notified automatically and indicating the authenticated user is absent in the vicinity of the computer.

4. The method according to claim 1, wherein the method is triggered by the authenticated user's sensitive operation.

5. The method according to claim 4, wherein the sensitive operation is performed on the computer.

6. The method according to claim 4, wherein the sensitive operation is performed by logging into another computer via the computer.

7. The method according to claim 4, wherein the sensitive operation comprises one or more of operation related to financial information, operation related to encrypted information, and operation related to system kernel information.

8. The method according to claim 1, wherein the security operation comprises one or more of locking screen, rejecting operation, blocking access, and notifying the authenticated user.

9. The method according to claim 2, wherein the RFID tag for the authenticated user is attached to the body and/or an accessory of the authenticated user.

10. A system for providing secure operation to a computer, comprising:
an identity tag disposed on an authenticated user, comprising a RFID tag;
a tag recognition module disposed on the computer, comprising a RFID reader, the tag recognition module generating and/or updating presence status of the authenticated user based on communication status between the RFID reader and the identity tag within the identity tag, the presence status indicating whether the authenticated user is present in the vicinity of computer; and
a security management module communicatively coupled to the tag recognition module, configured to trigger security operations in response to that the generated presence status of the authenticated user indicates the authenticated user is absent in the vicinity of the computer.

11. The system according to claim 10, further comprising:
an information maintenance module comprising a repository and configured to maintain the presence status generated by the tag recognition module.

12. The system according to claim 11, wherein the tag recognition module periodically updates the generated or updated presence status of the authenticated user to the information maintenance module via a message, and the message comprises one or more of the following relevant information: an identity tag identification code, an IP address of the computer, a specific identity tag being present in the vicinity of the computer, and a specific identity tag leaving the computer.

13. The system according to claim 11, wherein after the authenticated user logs into the computer, the security management module subscribes to the information maintenance module for an event regarding presence status change of the authenticated user, so when the authenticated user leaves the computer, the security management module obtains a message automatically notified by the information maintenance module and indicating the authenticated user is absent in the vicinity of the computer.

14. The system according to claim 11, wherein the security management module being configured to trigger security operations in response to that the generated presence status of the authenticated user indicates the authenticated user is absent in the vicinity of the computer further comprises:
when the security management module detects the authenticated user's sensitive operation, querying the information maintenance module about presence status of the authenticated user; and
in response to that the presence status of the authenticated user indicates the authenticated user is absent in the vicinity of the computer, triggering security operation.

15. The system according to claim 14, wherein the sensitive operation is performed on the computer, and the security management module is disposed on the computer.

16. The system according to claim 14, wherein the sensitive operation is performed by logging into another computer via the computer, and the security management module is disposed on said another computer.

17. The system according to claim 14, wherein the sensitive operation comprises one or more of operation related to financial information, operation related to encrypted information, and operation related to system kernel information.

18. The system according to claim 10, wherein the security operation comprises one or more of locking screen, rejecting operation, blocking access, and notifying the authenticated user.

19. The system according to claim 10, wherein the identity tag disposed on the authenticated user is attached to the body and/or an accessory of the authenticated user.

20. An apparatus for securely operating a computer, comprising:
a status obtaining module configured to obtain presence status of an authenticated user, the presence status indicating whether the authenticated user is present in the vicinity of the computer; and
a triggering module configured to trigger security operation in response to that the presence status indicates the authenticated user is absent in the vicinity of the computer.
